(19) United States
(12) Patent Application Publication
(10) Pub. No.: US 2016/0159247 A1
(43) Pub. Date: Jun. 9, 2016

(54) METHOD AND SYSTEM FOR COOLING WATER CONTROL OF VEHICLE

(71) Applicant: Hyundai Motor Company, Seoul (KR)

(72) Inventors: Dong Hun Lee, Anyang (KR); Kang Sik Jeon, Yongin (KR); Chang Seok Ryu, Anyang- Gyeonggi-do (KR); Min Su Kang, Paju- Gyeonggi-do (KR); Nam Woo Lee, Hwaseong (KR); Sung Do Kim, Seongnam (KR)

(21) Appl. No.: 14/708,257

(22) Filed: May 10, 2015

(30) Foreign Application Priority Data
Dec. 4, 2014 (KR) 10-2014-0172894

(51) Int. Cl. B60L 11/18; H01M 8/04

(52) U.S. Cl. CPC B60L 11/1892; H01M 8/04029; H01M 8/0432; H01M 8/04701; H01M 8/0494; B60L 11/189; B60L 11/1898; H01M 2250/20

(57) ABSTRACT

A system and method for a cooling water control of a vehicle are provided. The method for a cooling water control of a vehicle includes detecting a flow rate of cooling water and comparing the detected flow rate with a preset normal flow rate value. When the detected flow rate of cooling water is less than the preset normal flow rate value a cooling water pump speed command is increased until a power average value of the cooling water pump reaches a reference power value when the cooling water is normally circulated to increase an RPM of the cooling water pump.

### CROSS REFERENCE TO RELATED APPLICATION

The present application claims priority of Korean Patent Application Number 10-2014-0172894 filed on Dec. 4, 2014, the entire contents of which application are incorporated herein for all purposes by this reference.

### BACKGROUND

1. Technical Field

The present invention relates to a method and system for a cooling water control of a vehicle, and more particularly, to a method and system for a cooling water control of a vehicle capable of performing a compensation control on a cooling water pump speed based on a flow rate of cooling water.

2. Description of the Related Art

A fuel cell system which is mounted within a fuel cell vehicle is configured to include a hydrogen supply system configured to supply hydrogen to a fuel cell stack, an air supply system configured to supply oxygen in the air which is an oxidizing agent required for electrochemical reaction to the fuel cell stack, the fuel cell stack configured to generate electricity based on an electrochemical reaction of hydrogen and oxygen, and a heat and water management system configured to adjust an operating temperature of the stack while removing electrochemical reaction heat of the fuel cell stack.

The heat and water management system includes a pump configured to circulate cooling water to the fuel cell stack, a radiator configured to cool cooling water discharged after cooling from the fuel cell stack, and an ion filter configured to filter ions eluted from a cooling loop. An upper end of the radiator of the heat and water management system is mounted with a normal pressure cap and a reservoir is disposed in an air opening type structure and has an inside provided with a water level sensor. To mount the water level sensor of cooling water in the reservoir, a predetermined package space is required. Accordingly, it may be difficult to secure the package space. Further, even though the water level sensor is mounted within the system, the water level sensor does not sense a loss of cooling water when the cooling water including water and air is circulated and therefore merely recognizes that the cooling water continuously maintains a normal level.

In other words, the related art determines a cooling water shortage phenomenon using a water level sensor, a pressure sensor mounted in a pipe, or the like. However, the existing method may often incorrectly sense a sensing value due to disturbances, that is, effects such as a change in temperature of cooling water, a change in cooling loop due to opening and closing of a cooling line valve, and vibrations of vehicles or equipment. To improve the above problem, a flow sensor is mounted within a cooling water pipe, but such a flow sensor is expensive and may be difficult to mount due to inconvenience such as mounting of a separate pipe in which the flow sensor is mounted. Further, a method for maintaining cooling performance when cooling water is insufficient is required.

### SUMMARY

An object of the present invention is to provide a method and system for a cooling water control of a vehicle capable of performing a compensation control on a cooling water pump speed based on a flow rate of cooling water.

According to an exemplary embodiment of the present invention, a method for a cooling water control of a vehicle may include: detecting a flow rate of cooling water and comparing the detected flow rate with a preset normal flow rate value; and when the detected flow rate of cooling water is less than the preset normal flow rate value, increasing a cooling water pump speed command until a power average value of the cooling water pump reaches a reference power value when the cooling water is normally circulated to increase a revolutions per minute (RPM) of the cooling water pump.

In the increasing of the cooling water pump speed command, when the cooling water pump is in an operation condition in which efficiency of the cooling water pump is changed based on the RPM of the cooling water pump, the cooling water pump speed command may be adjusted using an efficiency map of the cooling water pump that corresponds to the RPM of the cooling water pump. The power average value of the cooling water pump may be a power average value of the cooling water pump calculated using a current command value input to a current controller which pulse width modulation (PWM) operates an inverter connected to the cooling water pump.

The method may further include: when the cooling water pump speed command increased in the increasing of the cooling water pump speed command exceeds a maximum RPM of the cooling water pump, calculating a cooling capacity based on a flow rate of cooling water of the cooling water pump rotating at a maximum RPM; and limiting a power of a fuel cell stack to not exceed the calculated cooling capacity.

The increasing of the cooling water pump speed command may include: calculating a power deviation of the cooling water pump over a set period of time; and additionally increasing the cooling water pump speed command as the calculated power deviation is increased. The limiting of the power of the fuel cell stack may include: calculating a power deviation of the cooling water pump over a set period of time; and increasing a power limitation amount of the fuel cell stack as the calculated power deviation is increased.

A size of the cooling water pump speed command which is additionally increased based on the calculated power deviation size may be linearly increased or may have a previously mapped relationship. A size of the power limitation amount of the fuel cell stack which is increased based on the calculated power deviation size may be linearly increased or may have a previously mapped relationship. When the detected flow rate of cooling water is less than a minimum reference flow rate, the increasing of the cooling water pump speed command may be not performed and the power of the fuel cell stack may be adjusted to a minimum power which is operated when the cooling water is not circulated.

### BRIEF DESCRIPTION OF THE DRAWINGS

The above and other objects, features and advantages of the present invention will be more clearly understood from the following detailed description taken in conjunction with the accompanying drawings, in which:

FIGS. 1A to 1C are exemplary graphs illustrating a relationship among a pressure difference between inlet and outlet stages of a cooling water pump, a flow rate of cooling water, and a power or a torque of a motor based on an RPM of a cooling water motor according to an exemplary embodiment of the present invention;

FIG. 2 is an exemplary graph illustrating a motor speed in a normal state and an abnormal state when a cooling water motor is operated at a fixed current by a method for determining a cooling water state according to an exemplary embodiment of the present invention;

FIG. 3 is an exemplary graph illustrating an average value of the power or torque of the cooling water motor based on a cooling water circulating state by the method for determining a cooling water state according to the exemplary embodiment of the present invention;

FIG. 4 is an exemplary block diagram schematically illustrating a structure of a controller which operates a cooling water pump according to an exemplary embodiment of the present invention; and

FIG. 5 is an exemplary flow chart illustrating a method for a cooling water control of a vehicle according to an exemplary embodiment of the present invention.

### DETAILED DESCRIPTION

Specific structural and functional descriptions will be provided to describe various exemplary embodiments of the present invention disclosed in the present specification or disclosure. Therefore, exemplary embodiments of the present invention may be implemented in various forms, and the present invention is not to be interpreted as being limited to exemplary embodiments described in the present specification or disclosure.

Since exemplary embodiments of the present invention may be various modified and may have several forms, specific exemplary embodiments will be shown in the accompanying drawings and will be described in detail in the present specification or disclosure. However, it is to be understood that the present invention is not limited to specific exemplary embodiments, but includes all modifications, equivalents, and substitutions included in the spirit and the scope of the present invention.

Terms such as ‘first’, ‘second’, etc., may be used to describe various components, but the components are not to be construed as being limited to the terms. The terms are used only to distinguish one component from another component. For example, the ‘first’ component may be named the ‘second’ component and the ‘second’ component may also be similarly named the ‘first’ component, without departing from the scope of the present invention.

It is to be understood that when one element is referred to as being “connected to” or “coupled to” another element, it may be connected directly to or coupled directly to another element or be connected to or coupled to another element, having the other element intervening therebetween. On the other hand, it is to be understood that when one element is referred to as being “connected directly to” or “coupled directly to” another element, it may be connected to or coupled to another element without the other element intervening therebetween. Other expressions describing a relationship between components, that is, “between”, “directly between”, “neighboring to”, “directly neighboring to” and the like, should be similarly interpreted.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Unless indicated otherwise, it is to be understood that all the terms used in the specification including technical and scientific terms have the same meaning as those that are understood by those who skilled in the art. It must be understood that the terms defined by the dictionary are identical with the meanings within the context of the related art, and they should not be ideally or excessively formally defined unless the context clearly dictates otherwise.

Hereinafter, exemplary embodiments of the present invention will be described in detail with reference to the accompanying drawings. Like reference numerals proposed in each drawing denote like components.

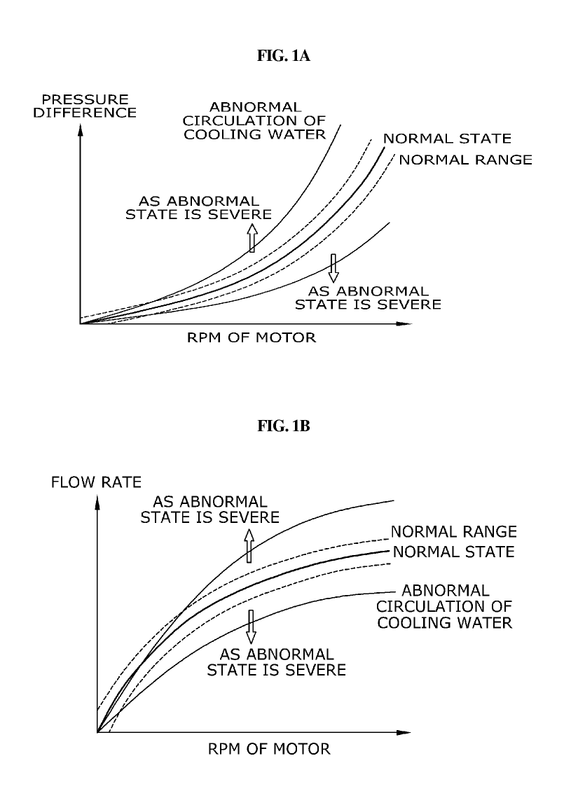

FIGS. 1A to 1C are exemplary graphs illustrating a relationship among a pressure difference between inlet and outlet stages of a cooling water pump, a flow rate of cooling water, and a power or torque of a motor based on an RPM of a cooling water motor. Referring to FIGS. 1A to 1C, when a sufficient amount of cooling water circulated in a cooling system, a pressure difference between inlet and outlet stages of a cooling water pump and a flow rate of cooling water may be operated in a normal range of a normal state value and thus a torque required to drive the cooling water pump at a constant speed may also be represented in a constant range of the normal state value. However, when the cooling water is not normally circulated, the torque or power of the motor deviates from the normal state range while the flow rate of cooling water and the pressure difference deviate from a normal range and due to a change in load of the cooling water pump, the operation speed of the cooling water pump does not also track a speed command value and is oscillated. The normal range differs depending on a structure of a cooling water pipe, and output at an abnormal state may be 20% or more less than that at a normal state.

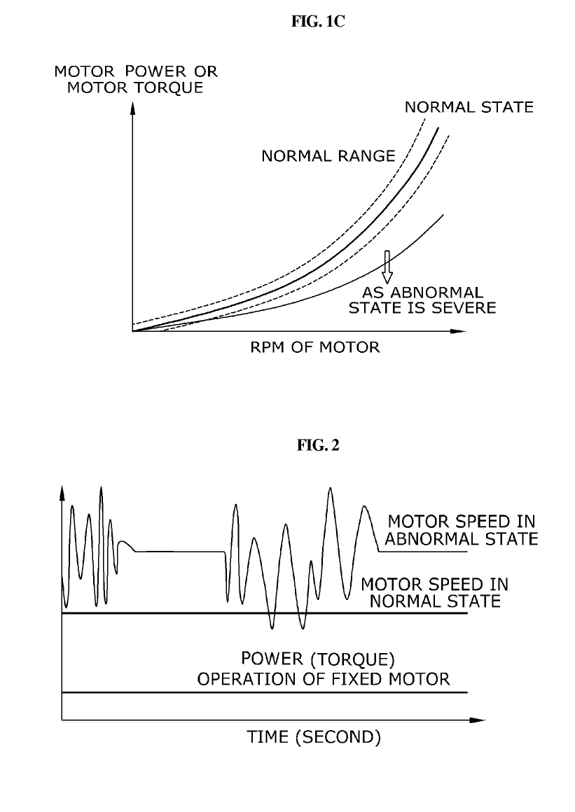

FIG. 2 is an exemplary graph illustrating a motor speed in the normal state and the abnormal state when a cooling water motor is operated at a fixed current by a method for determining a cooling water state according to an exemplary embodiment of the present invention. Referring to FIG. 2, when the cooling water motor is operated at a fixed current and thus the power or torque of the motor is substantially constant over a particular period of time, the RPM of the motor may be substantially constant when the cooling water circulating state is normal; however, the RPM of the motor may oscillate due to the change in load when the cooling water circulating state is abnormal, that is, when the cooling water is in an insufficient state, when the cooling water is leaked, or when the pipe stops.

In particular, when the power or torque of the motor is substantially constant over a particular period of time and the cooling water circulating state is abnormal, the load of the cooling water pump (e.g., motor) may be reduced due to bubbles formed in the cooling water pipe when the cooling water is insufficient and therefore the average RPM may be increased more than in the normal state and when the bubbles are introduced into the pump, the RPM may be oscillated due to the sudden change in load. Further, when the cooling water is substantially insufficient due to the leakage of cooling water, the bubbles may be continuously introduced into the pump and thus the RPM may be continuously oscillated, or water may not be discharged and thus the RPM may more rapid than that in the normal state.

Similar to when the bubbles are introduced, when foreign substances are circulated in the cooling water pipe, the load of the cooling water pump may be changed and thus the RPM may be oscillated. Further, when the cooling water pipe stops due to the existence of foreign substances or physical damage, the load may be suddenly reduced and thus the RPM of the cooling water pump may be greater than that in the normal state.

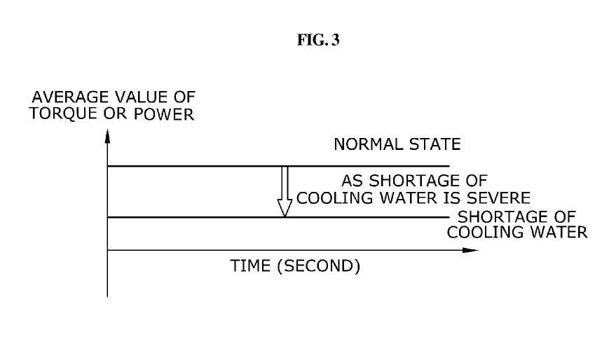

FIG. 3 is an exemplary graph illustrating an average value of the power or torque of the cooling water motor based on a cooling water circulating state by the method for determining a cooling water state according to the exemplary embodiment of the present invention. In particular, FIG. 3 illustrates comparison data of the power or torque of the motor when the flow rate of cooling water is normal and the flow rate of cooling water is insufficient. However, when the flow rate of cooling water is insufficient, the power or torque of the motor may be oscillated and FIG. 3 illustrates the average value of the power or torque of the motor. When the flow rate of cooling water is insufficient, the average value of the power of the motor may be reduced and the deviation thereof may occur.

As a method for obtaining a power or a torque of a motor, there are a method for measuring a current and a voltage of a direct current (DC)stage, a method for measuring a 3-phase current and voltage, a method for measuring a 3-phase current and voltage using a torque sensor, and a method for utilizing a torque map which is preset based on a change in speed and input voltage after a 3-phase current is measured, and the like. The current command may have a proportional relationship with the torque of the motor and thus the torque may be calculated based on the 3-phase current measurement value (e.g., vector sum of the 3-phase current) confirmed by the current command or the current sensor.

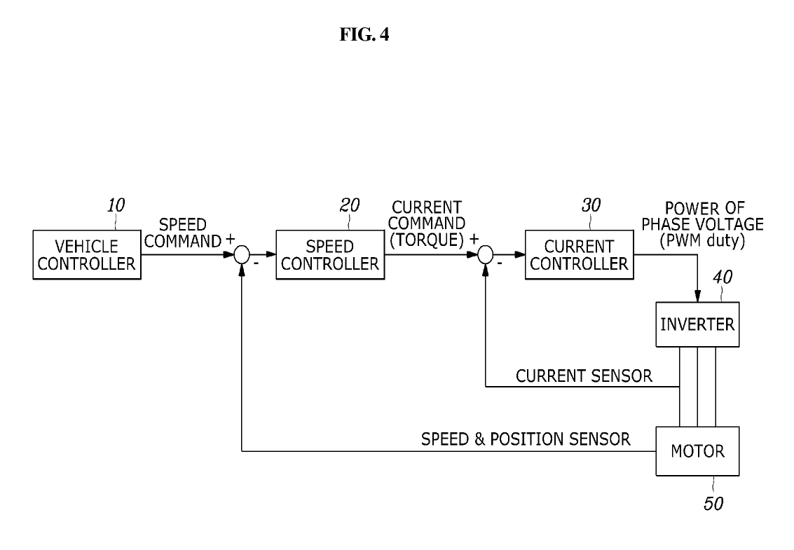

FIG. 4 is an exemplary block diagram schematically illustrating a structure of a controller configured to operate a cooling water pump according to an exemplary embodiment of the present invention. An inverter 40 may be connected to the cooling water pump motor 50 and may be PWM-controlled by a cuffent controller 30. In other words, the current controller 30 may be configured to determine a phase voltage power value to adjust a power cuffent of the inverter 40. Particularly, the current controller 30 may be configured to determine the phase voltage power value by being fed back with a current command value generated from the speed controller 20 and a power current sensing value of the inverter 40.

The current command value power from the speed controller 20 may have a proportional relationship with the torque of the cooling water pump motor 50 and thus the torque may be calculated based on the current command for the pump motor 50 or the power current sensing value (e.g., vector value of the 3-phase current confirmed by the current sensor) of the inverter 40. The relationship between the torque of the motor and the current may be applied to a substantially constant torque operation control area in which a field weakening operation is not performed but the general cooling water pump motor is operated in the substantially constant torque operation area. The speed controller 20 configured to adjust the RPM of the cooling water pump motor 50 may be configured to receive a speed command from the vehicle controller 10 and may be fed back with the current RPM sensing value of the cooling water pump motor 50 to generate the current command value and transmit the generated current command value to the current controller 30.

As the method for determining the power or torque of the cooling water pump motor 50, there are a method for multiplying a current and a voltage of a DC stage, a method for using a 3-phase current and voltage, a method for using a torque sensor, or a method for measuring a 3-phase current and then using torque map preset based on a change in RPM and input voltage of the cooling water pump motor 50.

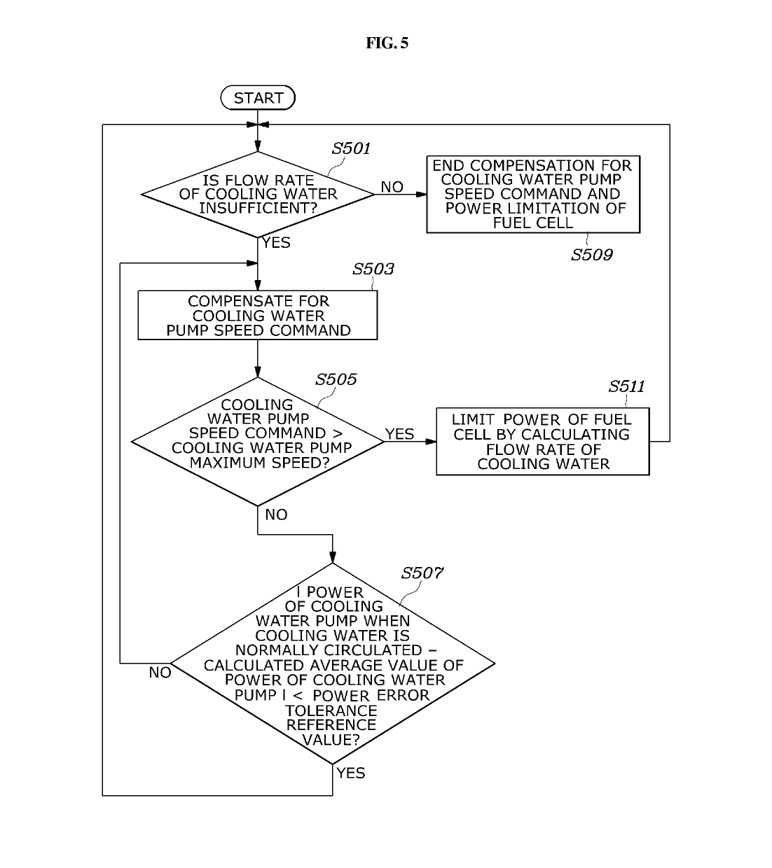

FIG. 5 is an exemplary flow chart illustrating a method for a cooling water control of a vehicle according to an exemplary embodiment of the present invention. The method for a cooling water control of a vehicle according to the exemplary embodiment of the present invention may include determining whether the flow rate of cooling water is insufficient or whether the circulation of cooling water is abnormal (S501). In other words, by detecting the flow rate of cooling water and comparing the detected flow rate with the preset normal flow rate value, when the detected flow rate of cooling water is less than the preset normal flow rate value, it may be determined that the flow rate of cooling water is insufficient.

The determination of whether the cooling water is insufficient or the circulation of cooling water is abnormal may be performed according to contents described in application No. KR 10-2014-0013723 which is filed by the same applicant and is incorporated herein by reference. Further, when the cooling water is insufficient or the circulation of cooling water is abnormal, the vehicle controller 10 may be configured to perform a compensation control on a cooling water pump speed command for increasing a cooling water pump speed command until a power average value of the cooling water pump motor 50 reaches a reference power value when the cooling water is normally circulated to increase the RPM of the cooling water pump motor 50 (S503). When the flow rate of cooling water is sufficient, the compensation for the cooling water pump speed command and a power limitation control for a fuel cell may end (S509).

Even when the flow rate of cooling water is more insufficient than that in the normal state, to secure the same cooling performance as that in the normal state, that is, to secure the same flow rate of cooling water as that in the normal state, the cooling water pump speed command may be increased. The compensation for the cooling water pump speed command may be performed until the current power average value of the cooling water pump motor 50 becomes lower than a power error tolerance reference value in an error from the power value of the cooling water pump when the cooling water is normally circulated (S507).

The average for the power value of the cooling water pump is measure to more determine a more accurate measurement based on a time average value due to the introduction of bubbles and the introduction of noise into the measurement sensor when the cooling water is insufficient. When the error between the average value of the power value of the cooling water pump motor 50 and the power value of the cooling water pump when the cooling water is normally circulated is less than the preset power error tolerance reference value, the flow rate of cooling water may be determined to be the same. This may be possible since the efficiency of the cooling water pump may not be changed significantly based on the RPM of the cooling water pump.

However, when the efficiency of the cooling water pump is significantly changed based on the operation condition, it may be possible to increase the cooling water pump speed command by reflecting a cooling water pump efficiency map. In other words, when the cooling water pump motor 50 is in the operation condition in which the cooling water pump efficiency is changed based on the RPM of the cooling water pump motor 50, the vehicle controller 10 may be configured to adjust the cooling water pump speed command using the cooling water pump efficiency map that corresponds to the RPM of the cooling water pump motor 50.

The power average value of the cooling water pump motor 50 may be the power average value of the cooling water pump calculated using the current command value input to the current controller 30 configured to PWM operate the inverter 40 connected to the cooling water pump motor 50. Further, when the cooling water pump speed command which is increased in the increasing of the cooling water pump speed command exceeds a maximum RPM of the cooling water pump motor 50 (S505), a cooling capacity calculated based on the flow rate of cooling water of the cooling water pump motor 50 rotating at the maximum RPM may be calculated and thus the power of the fuel cell stack may be limited to not exceed the calculated cooling capacity (S511).

The flow rate of cooling water may be secured by increasing the RPM command of the cooling water pump motor 50. When the speed command value of the cooling water pump motor 50 is greater than the rotatable speed of the cooling water pump motor 50, the compensation for the flow rate of cooling water by increasing the motor speed may be stopped and therefore the operation of limiting the power of the fuel cell stack may be performed (S511). The power limitation value of the fuel cell stack calculates the flow rate of cooling water based on the power value of the cooling water pump motor 50 driven at the maximum speed of the pump motor 50 and a total cooling capacity of the cooling system is calculated based on the flow rate of cooling water. The power of the fuel cell stack may be limited to the cooling capacity or less of the cooling system to secure the maximum power performance within the range in which the fuel cell stack is not heated.

In other words, whether the cooling water is normally circulated may be determined using the power of the cooling water pump motor 50 and when the power of the cooling water pump is less than that in the normal state due to the abnormal circulation of cooling water, the compensation control to increase the cooling water pump speed may be performed to secure the flow rate of cooling water, thereby securing the cooling performance in the normal state. Additionally, when the flow rate of cooling water is insufficient, the power of the system may be limited and thus the cooling performance and the power performance may be secured even when the cooling water is abnormally circulated.

Further, when the vehicle controller 10 increases the cooling water pump speed command, the power deviation of the cooling water pump may be calculated over a particular period of time and thus as the calculated power deviation is increased, the cooling water pump speed command may be additionally increased. Further, even when the power of the fuel cell stack is limited, the power deviation of the cooling water pump may be calculated over a particular period of time and thus the power limitation amount of the fuel cell stack may be increased with the increase in the calculated power deviation.

As illustrated in FIGS. 2 and 3, when the shortage of cooling water is increased, the power change amount of the cooling water pump motor 50 may be increased while the introduction of bubbles into the cooling water pump motor 50 is increased. When a substantial amount of bubbles are present in a cooling water pipe, even though the cooling water of the same flow rate is circulated, the cooling efficiency may be less than when no cooling water is present due to the bubbles and since an overheat phenomenon may locally occur due to the bubbles, as the power deviation value of the cooling water pump motor 50 is increased, the speed command value may be increased and the power limitation amount may be proportionally increased. The size of the cooling water pump speed command which may be additionally increased based on the calculated power deviation size and the size of the power limitation amount of the fuel cell stack may have a linear relationship or the previously mapped relationship.

When the detected flow rate of cooling water is less than a minimum reference flow rate, the cooling water pump speed command may not be increased and the power of the fuel cell stack may be limited to the minimum power which may be operated when the cooling water is not circulated. When the detected flow rate of cooling water is less than a minimum reference flow rate means, for example, when a leakage amount of cooling water is increased or the cooling water pipe stops to prevent the cooling water from being circulated. Accordingly, when an unloading operation in which the cooling water is not circulated is performed, the increase control in the speed command value of the cooling water pump motor 50 may not be performed and the power of the fuel cell may be limited up to the possible power without the cooling water.

Although the present invention has been described with reference to the exemplary embodiments shown in the accompanying drawings, they are only examples. It will be appreciated by those skilled in the art that various modifications and equivalent other exemplary embodiments are possible from the present invention. Accordingly, an actual technical protection scope of the present invention is to be defined by the following claims.

What is claimed is:

1. A method for a cooling water control of a vehicle, comprising:
detecting, by a controller, a flow rate of cooling water and comparing the detected flow rate with a preset normal flow rate value; and
when the detected flow rate of cooling water is less than the preset normal flow rate value, increasing, by the controller, a cooling water pump speed command until a power average value of a cooling water pump reaches a reference power value when the cooling water is normally circulated to increase revolutions per minute (RPM) of the cooling water pump.

2. The method of claim 1, wherein in the increasing of the cooling water pump speed command, when the cooling water pump is in an operation condition in which efficiency of the cooling water pump is changed based on the RPM of the cooling water pump, the cooling water pump speed command is adjusted using an efficiency map of the cooling water pump that corresponds to the RPM of the cooling water pump.

3. The method of claim 1, wherein the power average value of the cooling water pump is the power average value of the cooling water pump calculated using a current command value input to a current controller configured to pulse width modulation (PWM) operate an inverter connected to the cooling water pump.

4. The method of claim 1, further comprising:
when the cooling water pump speed command increased in the increasing of the cooling water pump speed command exceeds a maximum RPM of the cooling water pump, calculating, by the controller, a cooling capacity calculated based on the flow rate of cooling water of the cooling water pump rotating at a maximum RPM; and
limiting, by the controller, a power of a fuel cell stack to not exceed the calculated cooling capacity.

5. The method of claim 1, wherein the increasing of the cooling water pump speed command includes:
calculating, by the controller, a power deviation of the cooling water pump over a particular period of time; and
additionally increasing, by the controller, the cooling water pump speed command as the calculated power deviation is increased.

6. The method of claim 4, wherein the limiting of the power of the fuel cell stack includes:
calculating, by the controller, a power deviation of the cooling water pump over a particular period of time; and
increasing, by the controller, a power limitation amount of the fuel cell stack as the calculated power deviation is increased.

7. The method of claim 5, wherein a size of the cooling water pump speed command additionally increased based on the calculated power deviation size is linearly increased or has a previously mapped relationship.

8. The method of claim 6, wherein a size of the power limitation amount of the fuel cell stack increased based on the calculated power deviation size is linearly increased or has a previously mapped relationship.

9. The method of claim 1, wherein when the detected flow rate of cooling water is less than a minimum reference flow rate, the cooling water pump speed command is maintained and a power of a fuel cell stack is adjusted to a minimum power operated when the cooling water is not circulated.

10. A system for a cooling water control of a vehicle, comprising:
a memory configured to store program instructions; and
a processor configured to execute the program instructions, the program instructions when executed configured to:
detect a flow rate of cooling water and comparing the detected flow rate with a preset normal flow rate value; and
increase a cooling water pump speed command until a power average value of a cooling water pump reaches a reference power value when the cooling water is normally circulated to increase revolutions per minute (RPM) of the cooling water pump when the detected flow rate of cooling water is less than the preset normal flow rate value.

11. The system of claim 10, wherein in the increasing of the cooling water pump speed command, when the cooling water pump is in an operation condition in which efficiency of the cooling water pump is changed based on the RPM of the cooling water pump, the cooling water pump speed command is adjusted using an efficiency map of the cooling water pump that corresponds to the RPM of the cooling water pump.

12. The system of claim 10, wherein the power average value of the cooling water pump is the power average value of the cooling water pump calculated using a current command value input to a current controller configured to pulse width modulation (PWM) operate an inverter connected to the cooling water pump.

13. The system of claim 10, wherein the program instructions when executed are further configured to:
calculate a cooling capacity calculated based on the flow rate of cooling water of the cooling water pump rotating at a maximum RPM when the cooling water pump speed command increased in the increasing of the cooling water pump speed command exceeds a maximum RPM of the cooling water pump; and
limit a power of a fuel cell stack to not exceed the calculated cooling capacity.

14. The system of claim 10, wherein the program instructions when executed configured to increase the cooling water pump speed command are further configured to:
calculate a power deviation of the cooling water pump over a particular period of time; and
additionally increase the cooling water pump speed command as the calculated power deviation is increased.

15. The system of claim 13, wherein the limiting of the power of the fuel cell stack includes program instructions that when executed are configured to:
calculate a power deviation of the cooling water pump over a particular period of time; and
increase a power limitation amount of the fuel cell stack as the calculated power deviation is increased.

16. The system of claim 14, wherein a size of the cooling water pump speed command additionally increased based on the calculated power deviation size is linearly increased or has a previously mapped relationship.

17. The system of claim 15, wherein a size of the power limitation amount of the fuel cell stack increased based on the calculated power deviation size is linearly increased or has a previously mapped relationship.

18. The system of claim 10, wherein when the detected flow rate of cooling water is less than a minimum reference flow rate, the cooling water pump speed command is maintained and a power of a fuel cell stack is adjusted to a minimum power operated when the cooling water is not circulated.
